(19) United States
(12) Patent Application Publication
(10) Pub. No.: US 2014/0233109 A1
(43) Pub. Date: Aug. 21, 2014

(54) STRUCTURE AND METHOD FOR COMPENSATING TEMPERATURE DEPENDENT MAGNIFICATION AND FOCUS CHANGE

(71) Applicants: Hiromitsu Nakano, Yokosuka City (JP); Daniel Lambot, Leuze-en-Hainaut (BE); Koen Van Belle, Bellegem (Kortrijk) (BE)

(72) Inventors: Hiromitsu Nakano, Yokosuka City (JP); Daniel Lambot, Leuze-en-Hainaut (BE); Koen Van Belle, Bellegem (Kortrijk) (BE)

(73) Assignee: BARCO N.V., Kortrijk (BE)

(21) Appl. No.: 14/346,035

(22) PCT Filed: Sep. 30, 2011
(86) PCT No.: PCT/EP2011/067204

§ 371 Date: Mar. 20, 2014

(51) Int. Cl. G02B 7/02; G02B 7/10

(52) U.S. Cl. CPC G02B 7/028; G02B 7/10
USPC 359/700; 359/694

(57) ABSTRACT

A method and device is described for compensating ambient temperature dependent magnification and focus change of a zoom lens system, whereby an ambient temperature compensation structure cooperates with a rotational ring and an optical-element adjusting member such that a phase variation between the rotational ring and the optical-element adjusting member in response to an ambient temperature change is compensated and whereby the phase variation characterizes an optical property of the zoom lens system such as magnification or focus.

### FIELD OF THE INVENTION

The present invention relates to an ambient temperature compensation structure and method for compensating temperature dependent magnification and focus changes of a lens device.

### BACKGROUND OF THE INVENTION

Projection lenses are designed so as to come into focus at a predetermined image formation position at room temperature. However, when using projectors due to the extreme temperature of its light source it causes the ambient temperature of the projector to rise. As a result, because the lens elements have a temperature dependency on refractive indices, radiuses of surfaces and thickness, the optical power changes accordingly to the elevated ambient temperature. For instance, after switching a projector on, the focus on the screen gradually changes and the best focus plane is moved to backside of the screen (1.2 m) and the image on the screen becomes blurred.

U.S. Pat. No. 6,144,510 describes thermal compensation system for an optical lens that has a focus adjustment structure that comprises an actuator mounted within the optical lens including a wax motor that is responsive to temperature changes. For zoom lens systems U.S. Pat. No. 6,710,932 describes a zoom lens system using two lens barrels with different linear expansion coefficients which can cancel image location variation due to an ambient temperature change.

However recently the number of pixels of imaging devices have been increasing e.g. the largest number of pixels of an imaging device is now 4096 (H)×2400 (V) and consequently the pixel pitch has been becoming smaller for instance 6.4 micron. While the pixel pitch used to be big enough only the focus drift needed to be solved but as a result of a smaller pixel pitch not only does the focus drift need to be solved but also a magnification change or change in focal length. For instance in case the magnification is lowered with 0.1% in a higher ambient temperature, the image width on the screen becomes 4 pixels smaller than the width in the room temperature, if thus the number of pixels keeps increasing in the future to for instance 7680 (H)×4320(V), the image width on the screen becomes 8 pixels smaller and it will become even more visible.

Therefore a need exists to maintain the same magnification even if the ambient temperature changes in an image device.

### SUMMARY OF THE INVENTION

An object of the present invention is to provide an alternative ambient temperature compensation structure and an alternative method for compensating temperature dependent magnification and focus changes of a lens device.

This object is met by compensating a phase variation between a rotational ring and an optical-element adjusting member of said lens device as a result of a variation in ambient temperature.

The present invention discloses methods and means according to the independent claims of the present invention. The dependent claims relate to preferred embodiments.

The present invention provides an ambient temperature compensation structure for a zoom lens system, comprising:

an ambient temperature compensation element comprising a first end portion and a second end portion, the first end portion attached to a rotational ring of the zoom lens system and said second end portion attached to an optical-element adjusting member of the zoom lens system;
whereby the ambient temperature compensation structure cooperates with the rotational ring and the optical-element adjusting member such that a phase variation between said rotational ring and said optical-element adjusting member in response to an ambient temperature change is compensated and whereby said phase variation characterizes an optical property of said zoom lens system such as magnification or focus.

Preferably the compensation is accomplished autonomously. That the compensation is accomplished “autonomously” means in this document that it functions independently: once the operation is started without any active input, it continues until the operation is terminated, without intervention.

An important advantage of a structure in accordance with the invention is that it can be used by an unskilled operator. Another advantage is that the structure is convenient and very easy to use. In addition, because the ambient temperature compensation element is modular it can be applied to any optical device comprising a lens. As a result the ambient temperature compensation element can be easily replaced in case of malfunctioning. This offers a enormous advantage when for instance comparing to prior art where entire lens barrels of images devices have been replaced by materials having different linear expansion coefficients like in U.S. Pat. No. '932.

The compensation which is autonomous can be done preferably passively, but also actively. Passively by using an ambient temperature compensation structure or actively by controlling a motor unit of the zoom lens device.

In some embodiments the rotational ring is a zoom gear ring and whereby the optical-element adjusting member is a cam ring, the cam ring provided with at least one cam groove via which an optical-element holding member, provided with at least one cam follower that is engaged in the cam groove, is guided to move in the optical axis direction relative to said cam ring when said cam ring is rotated. Preferably the optical-element holding member is guided to move in the optical axis direction relative to said cam ring when said cam ring is rotated such that a focal plane of said lens device is kept at a constant focal plane.

In other embodiments, used for compensating a focus change due to an ambient temperature change, the rotational ring is a focus gear ring and the optical-element adjusting member is a focusing screw. Preferably the focusing screw is a helical screw

In yet another embodiment, the rotational ring is a zoom liner and the optical-element adjusting member is a cam ring, the cam ring provided with at least one phase compensation groove via which said ambient thermal compensation structure is guided.

Preferably the ambient thermal compensation structure is made of a cured resin, more specifically the cured resin is selected from a poly carbonate, a polyoxymethylene, a polypropylene, a polyallomer or mixtures thereof.

The dimensions of the structure according to embodiments of the invention can be dependent on dimensions of the zoom lens system or the optical or mechanical design of the zoom lens system or the material of the structure or the ambient temperature or a combination hereof.

The structure preferably further can comprise a means for guiding, whereby the means for guiding is attached to said rotational ring, and whereby the means for guiding guides the ambient thermal compensation structure into an inner or outer rotational direction, in addition preferably the optical-element holding member is a lens group that can be operated from wide-angle to telephoto or from telephoto to wide-angle.

Advantageously the optical aberration of the zoom lens device is kept constant using embodiments of the present invention.

Alternatively, a set of ambient temperature compensation elements for compensating a thermal magnification change and focus drift can be placed on a zoom lens device, the ambient temperature compensation elements of the set being adapted for changes in phase between a rotational ring and an optical-element adjusting member.

The present invention also provides a method for compensating a magnification or focus drift change of a zoom lens device as a result of an ambient temperature, the device comprising a rotation ring and an optical-element adjusting member and an ambient temperature compensation structure, the method comprising causing the ambient thermal compensation structure to respond to a temperature change such that variations in phase between the rotational ring and said optical-element adjusting member are compensated. Preferably the compensation is performed autonomously.

### BRIEF DESCRIPTION OF THE DRAWINGS

Further features of the present invention will become apparent from the drawings, wherein:

FIG. 1a is a schematic representation of an ambient temperature magnification change compensation structure for a lens device according to an embodiment of the invention.

FIG. 1b shows a cross-section of the ambient temperature magnification change compensation structure for a lens device illustrated in FIG. 1a.

FIG. 2a is a schematic representation of an ambient temperature magnification change compensation structure for a lens device according to an embodiment of the invention.

FIG. 2b shows a quarter cross-section of the ambient temperature magnification change compensation structure for a lens device illustrated in FIG. 2a.

FIG. 3a is a schematic representation of an ambient temperature focus change compensation structure for a lens device according to an embodiment of the invention.

FIG. 3b shows a quarter cross-section of the ambient temperature magnification change compensation structure for a lens device illustrated in FIG. 2a.

FIG. 4 shows the lens groups inside of a lens device.

### DETAILED DESCRIPTION OF EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

In the drawings, like reference numerals indicate like features; and, a reference numeral appearing in more than one figure refers to the same element.

There are many possible designs for zoom lenses; the most complex ones can have for example to up to thirty individual lens elements and multiple moving parts. Most, however, follow the same basic design. Generally a zoom lens can consist of a number of individual lenses or lens groups that may be either fixed, or slide axially along the body of the lens or the optical axis 40. While the magnification of a zoom lens changes, it is necessary to compensate for any movement of the focal plane to keep the focused image sharp. This compensation may be done by mechanical means (moving the complete lens assembly while the magnification of the lens changes) or optically (arranging the position of the focal plane to vary as little as possible while the lens is zoomed).

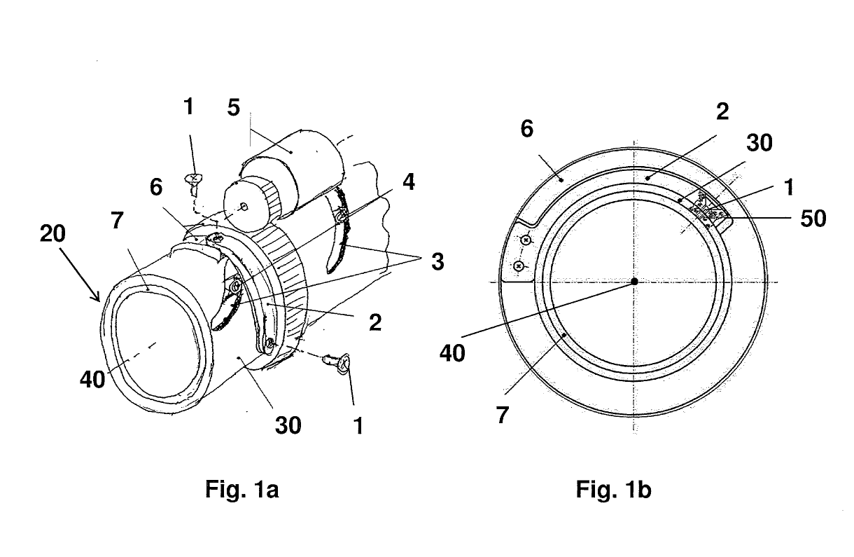

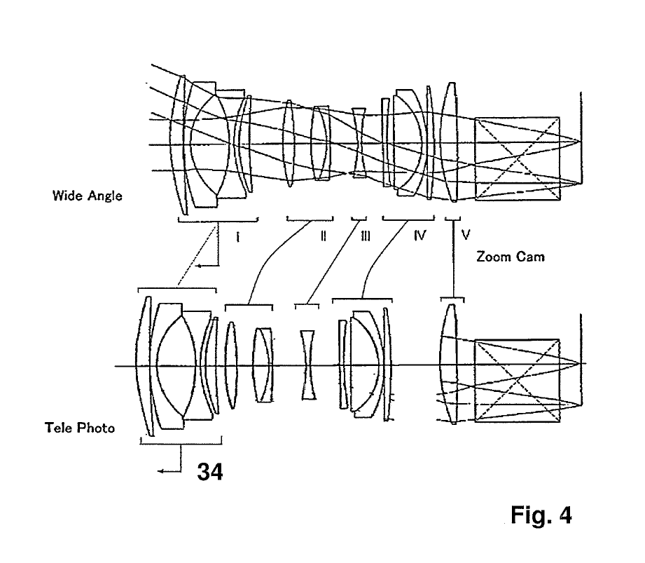

FIG. 1a shows a schematic representation of an ambient temperature magnification change compensation structure 10 for a lens device 20 according to an embodiment of the invention. The rotational ring 6 of a lens device 20 can include a peripheral gear at the rear end thereof with respect of the optical axis 40 and is preferably a zoom gear ring in this embodiment. The lens group inside the zoom liner 7 is movable in the optical axis 40 direction and can be driven by the driving force of a zoom motor unit 5. Upon the rotational driving force of the zoom motor unit 5 the cam ring 30 rotatably moves along the optical axis 40. When this is done from a fully-retracted state of the zoom lens barrel to within a zooming range, the lens groups, as illustrated in FIG. 4, change from a wide-angle extremity to a telephoto extremity. When the cam ring 30 rotates to a fixed position with respect to the optical axis 40 the zoom pins of the lens group 4 are guided by the semi-circumferential grooves 3. As a result, when using zoom lenses, the focus is kept at the same focal plane while the zoom function is operated from wide-angle to telephoto or from telephoto to wide-angle. An ambient temperature compensation structure 2 is attached preferably by screws 1 between the zoom gear ring 6 and the cam ring 30. Preferably the ambient temperature compensation structure 2 is made of a cured resin, more specifically a cured resin which is selected from a poly carbonate, a polyoxymethylene, a polypropylene, a polyallomer or mixtures thereof. As a result, the phase between the zoom gear ring 6 and the cam ring 30 can be expanded or shrunken according to the ambient temperature. Due to the thermal expansion or shrinkage of the thermal compensation structure, the zoom ring 6 can be rotated against its gear ring so that the lens groups are moved along the semi-circumferential grooves 3, and as described the earlier while keeping the focus at the same focal plane and as a result also the same optical aberration. Thus, only the magnification change as result of an ambient temperature change is compensated. The magnification or focal length is changing corresponding to the rotation angle of a cam ring. Normally a thermal magnification change at all zoom position will be the same, for instance, a 0.1% change in ambient temperature will reflect in a rotation change or phase variation of 10 degrees at any zoom position. As a result, the ambient thermal compensation element 2 according to an embodiment of the present invention is capable to compensate a phase variation for all zoom positions.

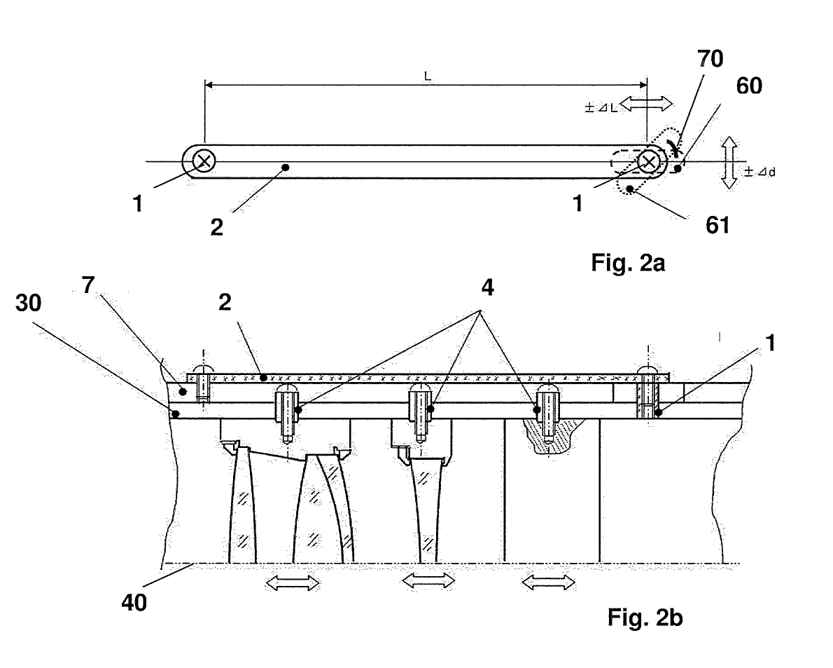

FIG. 2b shows a schematic representation of an ambient temperature magnification change compensation structure 10 for a lens device 20 according to an embodiment of the invention whereby said lens device is provide with a zoom liner which comprises a cam ring. The lens group inside the cam ring 30 is movable in the optical axis 40 direction and can be driven by the driving force of a zoom motor unit (not shown). Upon the rotational driving force of the zoom motor unit the zoom liner 7 rotatably moves along the optical axis 40. When the zoom liner 7 rotates to a fixed position with respect to the optical axis 40 the zoom pins of the lens group 4 are guided by the grooves 60 on the zoom liner. An ambient temperature compensation element 2 is attached preferably by screws 1 between the zoom liner 7 and the cam ring 30. Preferably the ambient temperature compensation element 2 is made of a cured resin, more specifically a cured resin which is selected from a poly carbonate, a polyoxymethylene, a polypropylene, a polyallomer or mixtures thereof. In this embodiment a phase compensation groove 61 is provided on the cam ring 30, having an inclination or gradient 70, as compared to the groove 60 on the zoom liner 7, said phase compensation groove 61 can enable compensation of a phase change. The groove 60 on the zoom liner 7 can restrict the movement direction of the ambient temperature compensation element 2, whereas the phase compensation groove 61 can be used when the ambient temperature compensation element 2 is expanding or shrinking. When a change in ambient temperature would occur, the ambient temperature element 2 having dimensions (L, d) will expand or shrink according to a respectively rise or fall in ambient temperature an amount (ΔL, Δd). When for instance this change in temperature would result in ΔL=1 mm and a phase difference of 1 mm between the cam ring and the zoom liner, the inclination or gradient 70 between the phase compensation groove 61 and the groove on the zoom liner 60 preferably is 45°. Thus for a 1:1 ratio between ΔL and the phase difference between the cam ring and the zoom liner, an inclination 70 of 45° is preferred. For a ratio above 1:1 the inclination should be changed accordingly, for instance by simulating the lens device using known simulation software found in the art, the inclination will preferably be higher than 45°. For a ratio below 1:1 the inclination should be changed and will preferably be lower than 45°. As a result, for a lens device 20 whereby the zoom liner 7 comprises the cam ring 30, the phase between the zoom liner 7 and the cam ring 30 can be expanded or shrunken according to the ambient temperature.

The dimensions (L, d) of the ambient thermal compensation element 2 and the dimensions as a result of an ambient temperature change (ΔL, Δd) for instance as illustrated in FIG. 2a, can be dependent on several factors, for instance the dimensions of the rotational ring, the material the ambient temperature compensation element 2 is made out of, the optical and mechanical design of the lens device 20 or the amount of change in ambient temperature in respect to the room temperature. In one example if the ambient temperature would rise up to 20° C. higher than the room temperature, the image size would become 5 pixels (2.5 pixels on one side) smaller than that in room temperature, as a result this would result in a shift of 2.5 pixel/20° C., or 0.125 pixel/° C. On the other hand, when using lens design simulation software and taking the above described mechanical design of the lens device into consideration, a phase variation of 0.0768 degrees is equivalent to a magnification change of 2 pixels (1 pixel on one side of the width of the screen). This means, the amount of compensation needed for 0.125 pixel/° C. would be equivalent to 0.125 pixel/° C.×0.0768 deg=0.0096 deg/° C. In case the outer diameter of a cam ring 30 as illustrated in FIG. 1b is 100 mm, the equivalent length of the thermal compensation element 2 on the cam ring is 8.378 micron/° C. and the length of the semi-circumferential thermal compensation part between the cam ring 30 and the zoom gear ring 6 should be (0.08378 mm/° C.)/(7×10⁻⁵/° C.)=120 mm, when using poly carbonate as material for an ambient temperature compensation element 2, the polycarbonate has a coefficient of thermal expansion of 7×10⁻⁵/° C. As a result, when using an ambient temperature compensation element 2 made out of polycarbonate position between the zoom gear ring 6 and the cam ring 30 a rise up to 20° C. higher than the room temperature can be spontaneously and passively compensated and the magnification change cause by the change of ambient temperature would be cancelled. It is obvious for the skilled person that a similar exercise can be done for various materials, temperatures and lens device design.

In other embodiments an active solution for magnification or focus compensation as a result of an ambient temperature change can be provided. In order to provide compensation, a rotational ring of a lens device should be rotated suitably such that a phase variation between said rotational ring and said optical-element adjusting member in response to an ambient temperature change is compensated. In order to adjust a rotational ring, a motor unit, for focus compensation this can be for instance be a focus motor unit, e.g. a stepper motor whereas for magnification compensation this can for instance be a zoom motor unit, can be used, e.g. a stepper motor. The number of steps necessary in order to compensate for the ambient temperature change can be easily calculated by using the results for instance obtained from a temperature sensor, which then can be provided to an encoder of the motor unit. In addition the step pulses can be counted, for instance by the motor unit control, while the motor unit is rotating. The algorithm for this active solution for magnification or focus compensation as a result of an ambient temperature change can be stored as a code on a non-transitory storage medium, for instance by means of embedded software on a piece of hardware of the lens device. However, when using the passive compensation as described above, one would only need one thermal compensation element, and not a complicated system as for the active solution.

In addition, in order to avoid that a compensation cannot be accomplished, for instance due to the mechanical limits and restrictions at a wide-angle extremity or at a telephoto extremity preferably the semi-circumferential grooves 3 need to be provided with enough room beyond the mechanical limitations.

Preferably, the ambient temperature compensation structure 10 further comprises a means for guiding 1, whereby the means for guiding 50 is attached to the rotational ring 6, and whereby the means for guiding guides the ambient thermal compensation element 2 into an inner or outer rotational direction. The means for guiding 50 can be elastic means for instance a spring that can push the ambient thermal compensation element 2 to one rotational direction (an inner rotation or counterclockwise or and outer rotation or clockwise) in order to avoid irregular distortion where the rotational ring 6 cannot be rotated enough for the right amount of compensation.

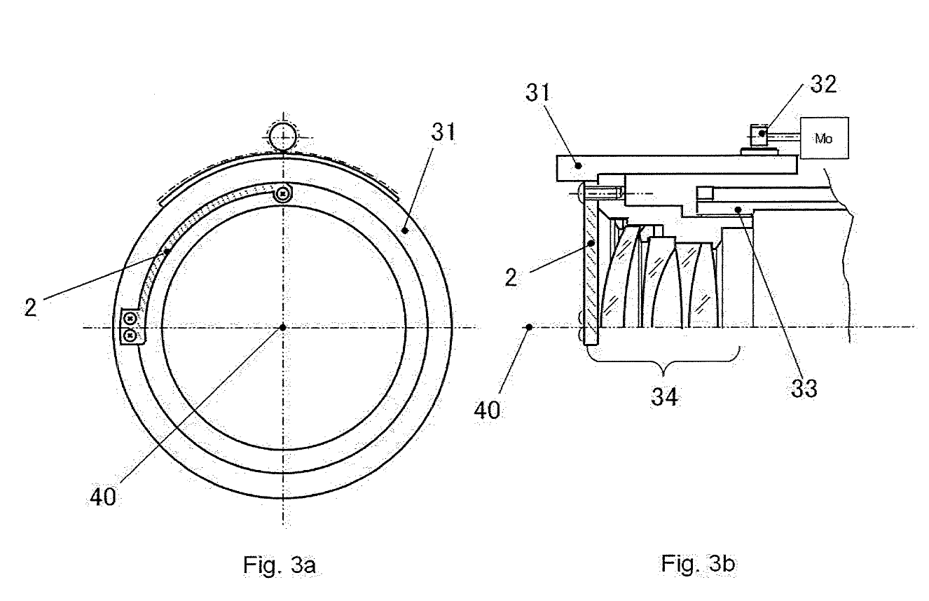

In another embodiment, an ambient thermal compensation element 2 can also be applied for compensating temperature dependent focus drift, by applying a non-expensive thermal compensation element 2 which is modular according to the present invention. This is illustrated in FIGS. 3a and FIG. 3b.

In this embodiment, the thermal compensation element 2 is applied for compensating temperature dependent focus drift. The ambient thermal compensation element 2 is attached between a focus gear ring and a focusing screw, more specifically a focusing helical screw. In this embodiment a focus drift due to a change in ambient temperature is compensated in addition since the thermal drift can be compensated along the focusing screw, all the optical aberration are kept constant. Again the dimensions of the ambient temperature compensation structure can be determined in a similar way as described above.

In yet another embodiment, at least two ambient temperature compensation elements can be attached to a lens device, one to compensate a phase change which reflects a change in magnification and one to compensate a phase change which reflects a change in focus. The dimensions of the ambient temperature compensation structure can be determined as described above.

It is to be understood that the invention is not limited to the particular features of the means and/or the process steps of the methods described as such means and methods may vary. It is also to be understood that the terminology used herein is for purposes of describing particular embodiments only, and is not intended to be limiting. It must be noted that, as used in the specification and the appended claims, the singular forms “a” “an” and “the” include singular and/or plural referents unless the context clearly dictates otherwise. It is also to be understood that plural forms include singular and/or plural referents unless the context clearly dictates otherwise. It is moreover to be understood that, in case parameter ranges are given which are delimited by numeric values, the ranges are deemed to include these limitation values.

The particular combinations of elements and features in the above detailed embodiments are exemplary only. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. An A zoom lens system including an ambient temperature compensation structure, comprising:
an ambient temperature compensation element (2) comprising a first end portion and a second end portion, said first end portion attached (1) to a rotational ring of said zoom lens system and said second end portion attached (1) to an optical-element adjusting member of said zoom lens system; and
whereby said ambient temperature compensation structure cooperates with said rotational ring and said optical-element adjusting member such that a phase variation between said rotational ring and said optical-element adjusting member in response to an ambient temperature change is compensated and whereby said phase variation characterizes an optical property of said zoom lens system such as magnification or focus.

2. The zoom lens system according to claim 1 whereby said compensation is accomplished autonomously.

3. The zoom lens system according to claim 1, whereby said rotational ring is a zoom gear ring and whereby said optical-element adjusting member is a cam ring, said cam ring provided with at least one cam groove via which an optical-element holding member, provided with at least one cam follower that is engaged in said cam groove, is guided to move in the optical axis direction relative to said cam ring when said cam ring is rotated.

4. The structure zoom lens system according to claim 3, whereby said optical-element holding member is guided to move in the optical axis direction relative to said cam ring when said cam ring is rotated such that a focal plane of said lens device is kept at a constant focal plane.

5. The zoom lens system according to claim 1, whereby said rotational ring is a focus gear ring and whereby said optical-element adjusting member is a focusing screw.

6. The zoom lens system according to claim 1, whereby said rotational ring is a zoom liner and whereby said optical-element adjusting member is a cam ring, said cam ring provided with at least one phase compensation groove via which said ambient thermal compensation structure is guided.

7. The zoom lens system according to any of the previous claims claim 1, wherein said ambient thermal compensation structure is made of a cured resin.

8. The zoom lens system according to claim 7, whereby said cured resin is selected from a poly carbonate, a polyoxymethylene, a polypropylene, a polyallomer or mixtures thereof.

9.-10. (canceled)

11. The zoom lens system according to claim 1, further comprising a means for guiding, whereby said means for guiding is attached to said rotational ring, and whereby the means for guiding guides the ambient thermal compensation structure into a clockwise or counterclockwise rotational direction.

12. The zoom lens system according to claim 1, whereby said optical-element holding member is a lens group that can be operated from wide-angle to telephoto or from telephoto to wide-angle.

13. A zoom lens system according to claim 1 comprising:
a first ambient temperature compensation element for compensating a thermal magnification change and
a second ambient temperature compensation element for compensating a thermal focus drift;
the ambient temperature compensation elements being adapted for changes in phase between a rotational ring and an optical-element adjusting member.

14. A method for compensating a magnification or focus drift change of a zoom lens device as a result of an ambient temperature, the device comprising a rotation ring and an optical-element adjusting member and an ambient temperature compensation structure, the method comprising causing said ambient thermal compensation structure to respond to a temperature change such that variations in phase between said rotational ring and said optical-element adjusting member are compensated.

15. The method according to claim 14, whereby said compensation is performed autonomously.
